(19) United States
(12) Patent Application Publication
(10) Pub. No.: US 2007/0013618 A1
(43) Pub. Date: Jan. 18, 2007

(54) Plasma display device and driving method therefor

(75) Inventors: Jae-Chul Jung, Seoul (KR); Ki-Woong Whang, Seoul (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/488,060

(22) Filed: Jul. 18, 2006

(30) Foreign Application Priority Data
Jul. 18, 2005 (KR) 10-2005-0064784

(51) Int. Cl. G09G 3/28

(52) U.S. Cl. 345/67

(57) ABSTRACT

In a plasma display device and a driving method therefor, address period operation is performed on a first group of first electrodes during at least a part of a period during which a sustain period operation is performed on a second group of first electrodes, and a reset discharge is generated by applying a first voltage to the first group of first electrodes, a second voltage to a plurality of second electrodes, and a third voltage to a plurality of third electrodes so that a first voltage difference between the first voltage and the third voltage is higher than a second voltage difference between the first voltage and the second voltage.

### CROSS-REFERENCE TO RELATED APPLICATION

This application claims the benefit of Korean Patent Application No. 2005-64784 filed on Jul. 18, 2005, in the Korean Intellectual Property Office, the disclosure of which is incorporated herein by reference in its entirety.

### BACKGROUND OF THE INVENTION

1. Field of the Invention

An aspect of the invention relates to a plasma display device and a driving method therefor.

2. Description of the Related Art

Recently, flat panel displays such as liquid crystal displays (LCDs), field emission displays (FEDs), and plasma display panels (PDPs) have been actively developed. PDPs are advantageous over the other flat panel displays in regard to their high luminance, high luminous efficiency, and wide viewing angle. Accordingly, PDPs are being highlighted as a substitute for conventional cathode ray tubes (CRTs) for large-screen displays of more than 40 inches.

A DC plasma display device has electrodes exposed in a discharge space so that a current flows in the discharge space while a voltage is applied, and hence requires a resistor to control the current. An AC plasma display device has a dielectric layer covering the electrodes and forming a capacitance element that controls the current. The AC plasma display device has a longer lifespan than the DC plasma display device since the electrodes are protected from ion shocks by the dielectric layer during discharge.

Methods for driving the AC plasma display device include an address-display-separation driving method (hereinafter, referred to as an “ADS driving method”), and an address-while-display driving method (hereinafter, referred to as an “AWD driving method”).

One plasma display frame is divided into a plurality of subfields, and each subfield includes a reset period, an address period, and a sustain period. The reset period is for initializing the status of each discharge cell so as to facilitate an addressing operation of the discharge cell, and the address period is for selecting turn-on/turn-off cells, which are the cells that must be turned on or turned off to display the intended image, and for accumulating wall charges on the turn-on cells that are addressed to be turned on. The sustain period is for sustain-discharging the discharge cell addressed during the address period so as to display an image on the addressed discharge cell.

In the ADS driving method, each subfield has the reset period, the address period, and the sustain period. The reset period is for initializing all the discharge cells, the address period is for applying a scan pulse to each scan electrode so as to perform an address operation, and the sustain period is for sustain-discharging the discharge cell that is addressed during the address period. The reset period, the address period, and the sustain period of each subfield are arranged in sequence for each discharge cell, the sustain periods of the respective subfields have different lengths to represent respective different weight values, and grayscales are realized by a combination of the subfields having respective different weight values.

In the AWD driving method, each scan electrode line is driven in a same sequence of the reset period, the address period, and the sustain period. However, operations of scan electrode of different lines are different from each other. That is, the scan electrode of an (n+1)th or an (n+m)th line experiences the sustain period while the scan pulse is applied to the scan electrode of an nth line to address the scan electrode of the nth line. Therefore, the address, sustain, and reset periods with respect to the scan electrodes are arranged in parallel, and grayscales of various scan electrode lines are expressed over 1 TV field or a plurality of TV fields.

The above AWD driving method has been disclosed in U.S. Pat. No. 6,495,968. However, the AWD driving method disclosed in U.S. Pat. No. 6,495,968 has a problem in that a contrast ratio is deteriorated since a pulse-type voltage of a reset waveform is applied for a short time to generate a reset discharge during the reset period.

The above information disclosed in this Background of the Invention section is provided only for enhancement of understanding of the background of the invention, and therefore it may include information that does constitute prior art that is already known in any country.

### SUMMARY OF THE INVENTION

In accordance with an aspect of the invention, there is provided a driving method for driving a plasma display device, the plasma display device including a plurality of first electrodes, a plurality of second electrodes, and a plurality of third electrodes crossing the plurality of first electrodes and the plurality of second electrodes, a plurality of discharge cells being formed where the plurality of third electrodes cross the plurality of first electrodes and the plurality of second electrodes, the plurality of first electrodes being divided into a plurality of groups each including at least one first electrode of the plurality of first electrodes, the driving method including performing a first subfield operation of a first subfield on the at least one first electrode of a first group of the plurality of groups; wherein the performing of the first subfield operation includes generating a reset discharge by applying a first voltage to the at least one first electrode of the first group, a second voltage to the plurality of second electrodes, and a third voltage to the plurality of third electrodes so that a first voltage difference between the first voltage applied to the at least one first electrode of the first group and the third voltage applied to the plurality of third electrodes is higher than a second voltage difference between the first voltage applied to the at least one first electrode of the first group and the second voltage applied to the plurality of second electrodes; selecting a discharge cell to be turned on from ones of the discharge cells that are formed along the at least one first electrode of the first group; and generating a sustain discharge in the selected discharge cell.

The generating of the reset discharge includes gradually increasing the first voltage difference and the second difference, and then gradually decreasing the first voltage difference and the second difference.

In the generating of the reset discharge, a first discharge is generated between the at least one first electrode of the first group and the plurality of third electrodes, and a second discharge weaker than the first discharge is generated between the at least one first electrode of the first group and the plurality of second electrodes.

The driving method further includes performing a second subfield operation of a second subfield on the at least one first electrode of a second group of the plurality of groups while the first subfield operation is being performed on the at least one first electrode of the first group; wherein the performing of the second subfield operation includes performing an address period operation of the second subfield during at least a part of a sustain period of the first subfield during which the sustain discharge is generated in the selected discharge cell.

In accordance with an aspect of the invention, a plasma display device includes a plasma display panel (PDP) including a plurality of first electrodes, a plurality of second electrodes, and a plurality of third electrodes crossing the first plurality of first electrodes and the plurality of second electrodes; a controller operable to perform a control operation wherein one frame is divided into a plurality of subfields each including a reset period, an address period, and a sustain period, and an address period operation of a second subfield of the plurality of subfields is performed on a jth first electrode of the plurality of first electrodes during a first period that is at least a part of the sustain period of a first subfield of the plurality of subfields during which a sustain period operation of the first subfield is performed on an ith first electrode of the plurality of first electrodes; and a driver operable to apply a first waveform to the ith first electrode, a first voltage to the plurality of second electrodes, and a second voltage lower than the first voltage to the plurality of third electrodes during the reset period of the first subfield; wherein the first waveform increases to a third voltage that is higher than the first voltage and then decreases while the first voltage is being applied to the plurality of second electrodes and the second is being applied to the plurality of third electrodes during the reset period of the first subfield.

The first waveform gradually increases to the third voltage and then gradually decreases.

During the reset period of the first subfield, a first discharge is generated between the ith first electrode and the plurality of third electrodes, and a second discharge weaker than the first discharge is generated between the ith first electrode and the plurality of second electrodes.

The plurality of subfields each further includes a second period between the reset period and the address period, and during the second period of the first subfield, a sustain discharge voltage is applied to the plurality of second electrodes a predetermined number of times while a predetermined voltage is applied to the ith first electrode.

At least a part of a sustain period operation of at least one other subfield of the plurality of subfields is performed on a kth first electrode of the plurality of first electrodes during the second period of the first subfield.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of embodiments of the invention, taken in conjunction with the accompanying drawings of which:

FIG. 1 is a top plan view of a plasma display device according to an aspect of the invention;

FIG. 2 shows a driving method of a plasma display device according to an aspect of the invention;

FIG. 3 shows driving waveforms of a plasma display device according to an aspect of the invention;

FIGS. 4A, 4B, 4C, and FIG. 4D show wall charge distributions produced by the driving waveforms shown in FIG. 3;

FIG. 5A shows infrared (IR) light waveforms that are generated when ramp waveforms having respective increasing slopes S1 to S7 are applied to a scan electrode while a reference voltage of 0V is applied to a sustain electrode;

FIG. 5B shows IR light waveforms that are generated when the ramp waveforms having the respective increasing slopes S1 to S7 are applied to the scan electrode while a Ve voltage of 150V is applied to the sustain electrode;

FIG. 6 shows driving waveforms applied to two scan electrode groups;

FIGS. 7A, 7B, and 7C show driving waveforms in which the driving waveforms applied during the sustain and erase periods of the first subfield shown in FIG. 3 are modified;

FIG. 8 shows a graph of a minimum address voltage versus a sustain discharge voltage when using a driving method according to an aspect of the invention and when using a conventional ADS driving method;

FIG. 9 shows a graph of an address voltage Va versus a scan pulse voltage |VscL| when using a driving method according to an aspect of the invention;

FIG. 10 shows a graph of a minimum address voltage versus a sustain discharge voltage when an amount of Xe in an Ne—Xe gas mixture is varied when using a driving method according to an aspect of the invention;

FIG. 11 shows a graph of a minimum address voltage versus a sustain discharge voltage when an amount of Xe in an Ne—Xe gas mixture is varied from 4% to 14% when using a driving method according to an aspect of the invention; and

FIG. 12 shows graph of an address intermediate voltage versus an amount of Xe in an Ne—Xe gas mixture obtained based on the graph shown in FIG. 11, in comparison with values obtained when using a conventional ADS driving method.

### DETAILED DESCRIPTION OF THE EMBODIMENTS

Reference will now be made in detail to embodiments of the invention, examples of which are shown in the accompanying drawings, wherein like reference numerals refer to like elements throughout. The embodiments are described below in order to explain the invention by referring to the figures.

The term “wall charges” in the following description refer to charges formed and accumulated on a wall (e.g., a dielectric layer) close to an electrode of a discharge cell. The wall charges will be described as being “formed” or “accumulated” on the electrode, although the wall charges do not actually touch the electrodes. Further, the term “wall voltage” in the following description refers to a potential difference induced on the wall of the discharge cell by the wall charges.

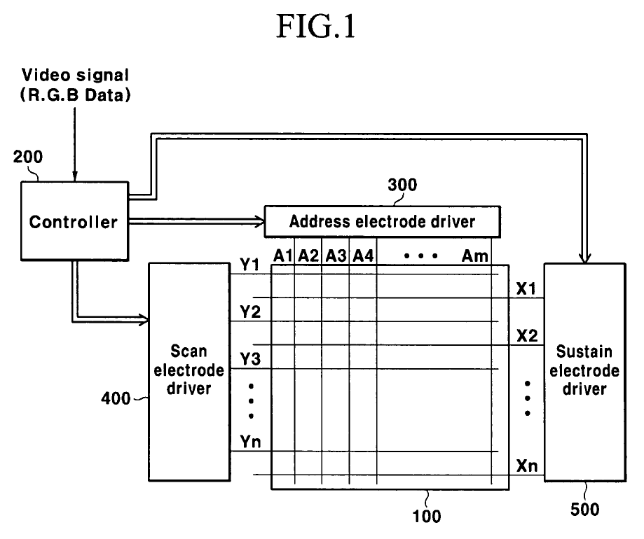

FIG. 1 is a top plan view of a plasma display device according to an embodiment of the invention.

As shown in FIG. 1, a plasma display device according to an aspect of the invention includes a plasma display panel (PDP) 100, a controller 200, an address electrode driver 300, a scan electrode driver 400, and a sustain electrode driver 500.

The PDP 100 includes a plurality of address electrodes A1-Am extending in a column direction, and a plurality of sustain and scan electrodes X1-Xn and Y1-Yn extending in a row direction and arranged in pairs of one sustain electrode X and one scan electrode Y. The sustain electrodes X1-Xn are formed in respective correspondence to the scan electrodes Y1-Yn, and ends of the sustain electrodes X1-Xn are connected in common. The PDP 100 further includes a substrate (not shown) supporting the sustain and scan electrodes X1-Xn and Y1-Yn, and a substrate (not shown) supporting the address electrodes A1-Am. The two substrates are arranged to face each other with a discharge space between them so that the scan electrodes Yl-Yn and the sustain electrodes X1-Xn cross the address electrodes Al-Am. Portions of the discharge space at intersections of the address electrodes A and the sustain and scan electrodes X and Y electrodes form discharge cells. This structure of the plasma display panel 100 is merely an example, and driving waveforms according to an aspect of the invention that will be described below may be applied to a plasma display panel having a different structure.

The controller 200 receives an external video signal such as RGB data, and outputs an address driving control signal, a sustain electrode driving control signal, and a scan electrode driving control signal. The controller 200 also divides a frame into a plurality of subfields, and performs a control operation in an address-while-display (AWD) driving method in which a sustain pulse is applied to a scan electrode while a scan pulse is applied to another scan electrode to address the other scan electrode.

The address electrode driver 300 receives the address driving control signal from the controller 200, and applies a display data signal for selecting turn-on discharge cells (i.e., discharge cells to be turned on) to the address electrodes.

The scan electrode driver 400 receives the scan electrode driving signal from the controller 200, and applies a driving voltage to the scan electrodes.

The sustain electrode driver 500 receives the sustain electrode driving control signal from the controller 200, and applies a driving voltage to the sustain electrodes.

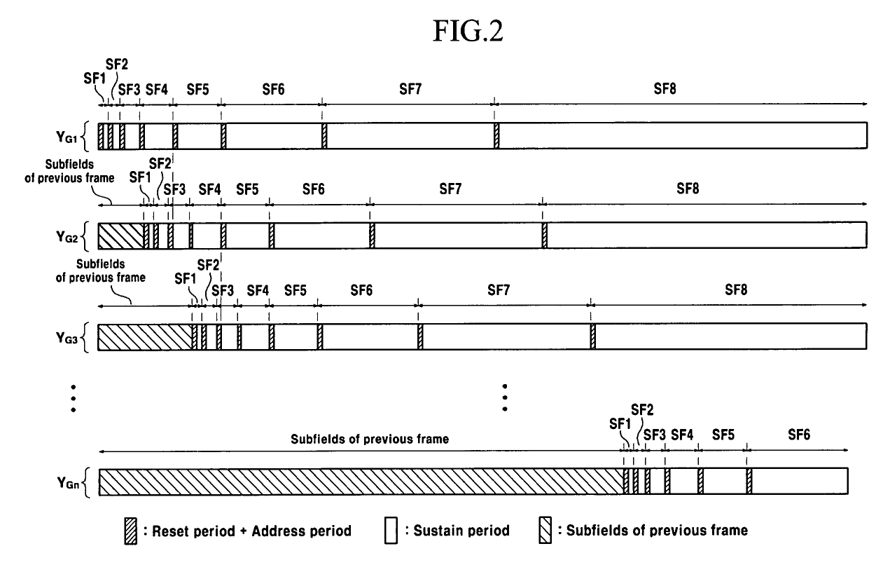

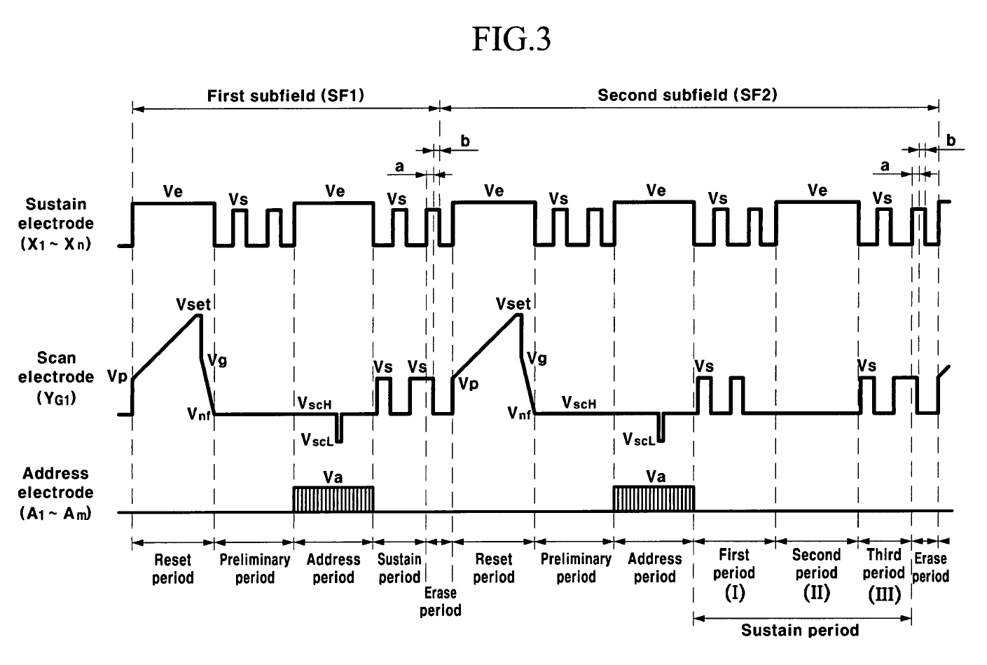

FIG. 2 shows a driving method of a plasma display device according to an aspect of the invention. The driving method shown in FIG. 2 is an AWD driving method. In FIG. 2, a reset period and an address period are combined into one period for convenience of description, but the reset period and the address period are actually two separate periods as described below in connection with FIG. 3.

Referring to FIG. 2, a plurality of scan electrodes Y1 to Yn are grouped as a plurality of scan electrode groups YG1, YG2, YG3, . . . , and YGn each including a plurality of scan electrodes Y, and one frame is divided into a plurality of subfields SF1, SF2, . . . , and SF8. Each of the subfields includes a reset period, an address period, and a sustain period, and the sustain period of each subfield has a length corresponding to a weight value of the subfield. Although one frame is divided into eight subfields SF1 to SF8 in FIG. 2, one frame may be divided into more or less than eight subfields. Also, although each of the scan electrode groups YG1 to YGn includes a plurality of scan electrodes Y in FIG. 2, each of the scan electrode groups YG1 to YGn may include a single scan electrode Y.

The reset and address period operations of each subfield are performed for a predetermined scan electrode group while the sustain period operation of a predetermined subfield is performed for the other scan electrode groups. In addition, the reset and address period operations of the respective subfields performed for the respective scan electrode groups are not overlapped with each other. For example, as shown in FIG. 2, the respective reset and address period operations of first to third subfields SF1 to SF3 are performed for a scan electrode group YG2 while the sustain period operation of a fourth subfield SF4 is performed for a first scan electrode group YG1 and the sustain period operations of predetermined subfields (not shown) are performed for the other scan electrode groups YG3 to YGn. Further, the respective reset and address period operations of fourth to eighth subfields SF4 to SF8 are performed for the second scan electrode group YG2 while the sustain period operations of various subfields are performed for the other scan electrode groups YG1 and YG3 to YGn.

In addition, as shown in FIG. 2, while the operations of the first to third subfields SF1 to SF3 of a current frame are performed for the first scan electrode group YG1, operations of subfields of a previous frame are performed for the other scan electrode groups YG2-YGn. While the operations of the first to eighth subfields SF1 to SF8 of the first scan electrode group YG1 are performed during one frame, the operations of the subfields of the other scan electrode groups YG2 to YGn are performed after the corresponding operations of the subfields of the first scan electrode group YG1, and therefore cannot be performed during one frame. Accordingly, the subfield operations that cannot be performed during the current frame are performed in the next frame.

Accordingly, a driving method according to an aspect of the invention generates a sustain discharge by applying a sustain pulse to a jth scan electrode group YGj while an ith scan electrode group YGi is addressed by applying a scan pulse to the ith scan electrode group YGi. That is, the AWD driving method for concurrently performing addressing and display operations is used in a driving method according to an aspect of the invention.

Driving waveforms in an AWD driving method according to an aspect of the invention will now be described with reference to FIG. 3 to FIG. 7C.

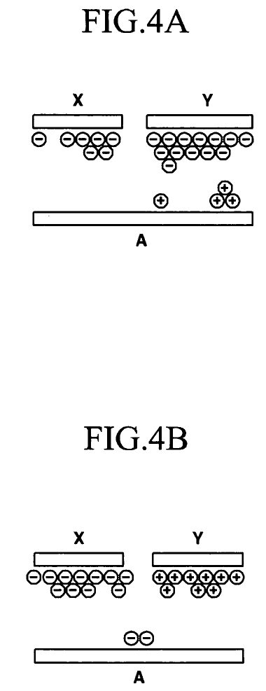

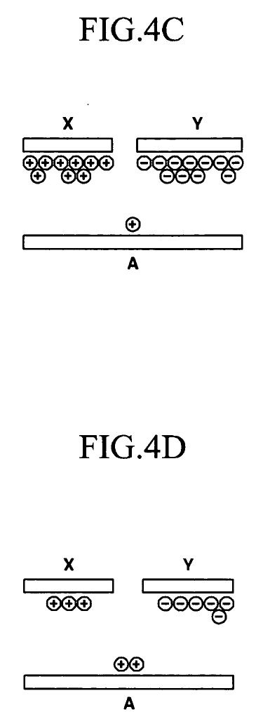

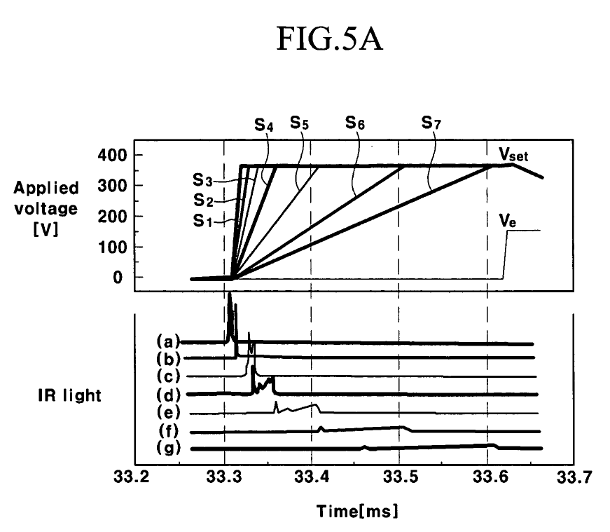

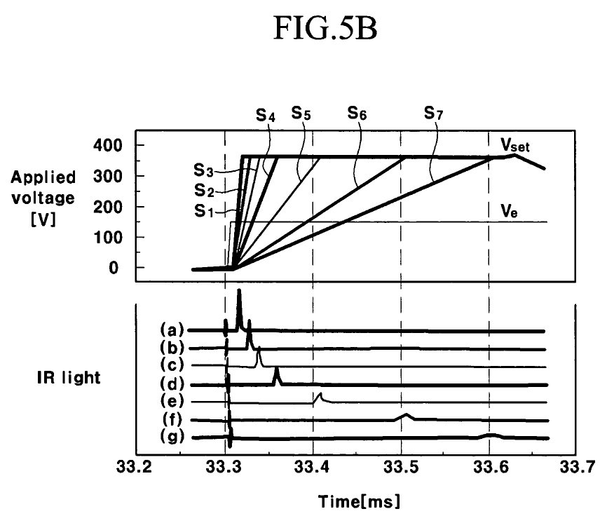

FIG. 3 shows driving waveforms of a plasma display device according to an aspect of the invention, and FIGS. 4A, 4B, 4C, and 4D show wall charge distributions produced by the driving waveforms shown in FIG. 3. For convenience of description, the driving waveforms applied to the first scan electrode group YG1 of the plurality of scan electrode groups YG1 to YGn are shown in FIG. 3. The driving waveforms applied to the other scan electrode groups YG2 to YGn are the same as those of the first scan electrode group YG1, and are applied to the other scan electrode groups YG2 to YGn using the AWD driving method in which the driving waveforms are applied to the scan electrode groups YG1 to YGn at different times. Also, wall charges formed on only one scan electrode Y, only one sustain electrode X, and only one address electrode A are shown in FIGS. 4A, FIG. 4B, 4C, and 4D for convenience of description.

As shown in FIG. 3, each subfield includes a reset period, an address period, a sustain period, and an erase period, and a preliminary period may be provided between the reset period and the address period.

First, during the reset period of the first subfield SF1, while a Ve voltage is applied to the sustain electrodes X1 to Xn and a reference voltage (OV in FIG. 3) is applied to the address electrodes A1 to Am, a reset waveform gradually increasing from a Vp voltage to a Vset voltage and gradually decreasing from a Vg voltage to a Vnf voltage is applied to the first scan electrode group TG1. Ve, Vp, and Vg may all be different, or any two of them may be the same and the other may be different, or all of them may be the same. Making Ve, Vp, and Vg the same has the advantage of simplifying the power supply required to supply these voltages. Although 0V is used for the Vnf voltage in FIG. 3, another voltage may be used. This causes wall charges to be uniformly formed in the discharge cells since a reset discharge is generated in the discharge cells formed along the scan electrodes of the first scan electrode group TG1. Since a voltage gradually increasing from the Vp voltage to the Vset voltage is applied to the first scan electrode group YG1 while the Ve voltage and the reference voltage OV are respectively applied to the sustain electrodes X1 to Xn and the address electrodes A1 to Am, a weak discharge is generated between the first scan electrode group YG1 and the address electrodes A1 to Am, and hardly any discharge is generated between the first scan electrode group YG1 and the sustain electrodes X1 to Xn. In addition, since a voltage gradually decreasing from the Vg voltage to the Vnf voltage 0V is applied to the first scan electrode group YG1 while the Ve voltage and the reference voltage OV are respectively applied to the sustain electrodes X1 to Xn and the address electrodes A1 to Am, hardly any discharge is generated between the first scan electrode group YG1 and the address electrodes A1 to Am and the sustain electrodes X1 to Xn. Therefore, as shown in FIG. 4A, at the end of the reset period, negative (−) wall charges have been formed on the scan electrode Y and the sustain electrode X, and positive (+) wall charges have been formed on the address electrode A.

As described above, the discharge cells are initialized because a reset discharge which is a weak discharge is generated between the scan electrode and the address electrode during the reset period according to an aspect of the invention. When the reset discharge is generated between the scan electrode and the address electrode, an increasing slope of the ramp waveform from the Vp voltage to the Vset voltage may be steeper compared to when a reset discharge is generated between the scan electrode and the sustain electrode and between the scan electrode and the address electrode.

FIG. 5A shows infrared (IR) light waveforms that are generated when ramp waveforms having respective increasing slopes S1 to S7 are applied to the scan electrode while the reference voltage OV is applied to the sustain electrode, and FIG. 5B shows IR light waveforms that are generated when the ramp waveforms having the respective increasing slopes S1 to S7 are applied to the scan electrode while the Ve voltage 150V is applied to the sustain electrode. In FIG. 5A and FIG. 5B, the IR light waveforms (a) to (g) respectively correspond to the increasing slopes S1 to S7. In addition, the reference voltage 0V is applied to the address electrode in FIG. 5A and FIG. 5B. That is, FIG. 5A shows the IR light waveforms when the reset discharge is generated between the scan electrode and the sustain electrode, and FIG. 5B shows the IR light waveforms when the reset discharge is generated between the scan electrode and the address electrode.

Comparing FIG. 5A and FIG. 5B, the reset discharge generated between the scan electrode and the address electrode as shown in FIG. 5B is weaker than the reset discharge generated between the scan electrode and the sustain electrode as shown in FIG. 5A when the same increasing slope is provided. For example, in a case of the slope S4, the weaker discharge is generated in FIG. 5B since the IR light waveform (d) shown in FIG. 5B is weaker than the IR light waveform (d) shown in FIG. 5A. Therefore, when the reset discharge is generated between the scan electrode and the address electrode by using a reset waveform according to an aspect of the invention, the weak reset discharge may be generated by using a steeper increasing slope.

According to an aspect of the invention, a short reset period may be applied, and subfields may be freely arranged among neighboring scan electrode lines as a result of using the AWD driving method in which the sustain discharge is performed by applying the sustain pulse to a scan electrode while another scan electrode is addressed by applying the scan pulse thereto. In contrast, subfields cannot be freely arranged among neighboring scan lines in the conventional ADS driving method, which causes a false dynamic contour problem to occur. It is necessary to perform an additional image processing such as dithering or error diffusion to correct this problem when using the conventional ADS driving method, but a high image quality may be obtained without this additional image processing according to an aspect of the invention which uses the AWD driving method instead of the conventional ADS driving method.

Although the reset waveform applied to the first scan electrode group YG1 during the reset period is shown as a ramp pattern in FIG. 3, other gradually increasing waveforms, such as a resistor-capacitor (RC) waveform and a staircase waveform, may be used in a driving method according to an aspect of the invention.

Next, during the preliminary period, a pulse having a sustain discharge voltage Vs (hereinafter also referred to as a “sustain pulse”) is applied to the sustain electrodes X1 to Xn a predetermined number of times while the Vnf voltage and the reference voltage OV are respectively applied to the first scan electrode group YG1 and the address electrodes A1 to Am. Although FIG. 3 shows that Vs is lower than Ve, Vs may be the same or higher than Ve. Making Vs and Ve the same has the advantage of simplifying the power supply required to supply these voltages. Since negative (−) wall charges have been formed on the scan electrodes and the sustain electrodes at the end of the reset period as shown in FIG. 4A, no discharge is generated in the discharge cells formed along the first scan electrode group YG1 when the sustain discharge voltage Vs is applied to the sustain electrodes X1 to Xn. The preliminary period is used for eliminating priming particles generated in the discharge cells formed along the first scan electrode group YG1 during the reset period, and is used as a sustain period for generating a sustain discharge in the discharge cells formed along the other scan electrode groups YG2 to YGn in cooperation with a sustain discharge voltage Vs that is applied to the other scan electrode groups YG2 to YGn. The preliminary period may be omitted if it is not used as the sustain period of the other scan electrode groups YG2 to YGn.

During the address period, a scan pulse voltage VscL is applied to a sequentially selected one of the scan electrodes of the first scan electrode group YG1 while the sustain electrodes X1 to Xn are biased at the Ve voltage, and an address voltage Va is applied to selected ones of the address electrodes A1 to Am to turn on selected ones of the discharge cells formed along the selected scan electrode to which the scan pulse VscL is applied. The video signal shown in FIG. 1 determines which discharge cells are to be turned on. A VscH voltage is applied to the other scan electrodes of the first scan electrode group YG1 to which the scan pulse voltage VscL is not applied. As a result, a discharge is generated between the scan electrode receiving the scan pulse voltage VscL and each of the address electrodes receiving the address voltage Va, and this discharge generates an address discharge between the scan electrode receiving the scan pulse voltage VscL and the neighboring sustain electrode X in each of the discharge cells that is to be turned on. Accordingly, as shown in FIG. 4B, at the end of the address period, positive (+) wall charges have been formed on the scan electrode Y, and negative (−) wall charges have been formed on the sustain electrode X. Although a level of the VscH voltage is the same as that of the Vnf voltage in FIG. 3, the level of the VscH voltage may be higher than that of the Vnf voltage.

Next, during the sustain period, the sustain pulse is applied to the first scan electrode group YG1, and a sustain discharge is generated in the discharge cells selected during the address period. This sustain discharge causes negative (−) wall charges to be formed on the scan electrode Y and positive (+) wall charges to be formed on the sustain electrode X as shown in FIG. 4C. Next, the sustain pulse is applied to the sustain electrodes X1 to Xn, which causes another sustain discharge to be generated. The sustain pulse is alternately applied to the first scan electrode group YG1 and the sustain electrodes X1 to Xn a predetermined number of times corresponding to a weight value allocated to the first subfield. In the example shown in FIG. 3, the sustain pulse is applied three times, thereby generating three sustain discharges in the sustain period.

The erase period is divided into an erase period a and an erase period b as shown in FIG. 3. A sustain discharge is generated at the end of the sustain period immediately before the beginning of the erase period by applying the sustain pulse to the first scan electrode group YG1, and the application of the Vs voltage to the first scan electrode group YG1 continues into the erase period. The Vs voltage is applied to the sustain electrodes X1 to Xn during the erase period a while the Vs voltage is still being applied to the first scan electrode group TG1. Since the same Vs voltage is being applied to the sustain electrodes X1 to Xn and to the first scan electrode group YG1 during the erase period a, no discharge is generated during the erase period a. Next, during the erase period b, the Vs voltage continues to be applied to the sustain electrodes X1 to Xn while the reference voltage OV is applied to the first scan electrode group TG1. Since the sustain pulse was applied to the first scan electrode group YG1 at the end of the sustain period immediately before the erase period as described above, the wall charges on the electrodes X, Y, and A at the beginning of the erase period b are as shown in FIG. 4C. Since the Vs voltage and the reference voltage 0V are respectively applied to the sustain electrodes X1 to Xn and the first scan electrode group YG1 during the erase period b, a discharge is generated in the discharge cells in which a sustain discharge was produced during the sustain period (i.e., the discharge cells selected during the address period). Next, at the end of the erase period b, the reference voltage OV is applied to the scan electrodes X1 to Xn, which extinguishes the discharge since the same reference voltage OV is now being applied to the scan electrodes X1 to Xn and the first scan electrode group TG1. The discharge generated during the erase period b is a weak discharge because it is generated for only a short time before being extinguished since the erase period b is short (the erase period b is shorter than a period of the sustain pulse for applying the Vs voltage to perform the sustain discharge), and accordingly some of the wall charges formed on the sustain electrode X and the scan electrode Y are eliminated as shown in FIG. 4D. The erase period according to an aspect of the invention may be simply realized since it is implemented by adjusting a time for applying the sustain discharge voltage Vs to the sustain electrodes X1 to Xn and the first scan electrode group TG1. The erase period b may be appropriately set so that the discharge is generated and the wall charges formed on the sustain electrode X and the scan electrode Y are eliminated.

Like the first subfield, the second subfield includes a reset period, a preliminary period, an address period, a sustain period, and an erase period. The second subfield is the same as the first subfield except that the sustain period of the second subfield is different from that of the first subfield as described below, and accordingly descriptions of the other parts of the second subfield will be omitted.

As shown in FIG. 3, the sustain period of the second subfield includes a first period I, a second period II, and a third period III. In the first period I, the sustain pulse is applied four times, alternating between the first scan electrode group YG1 and the sustain electrodes X1 to Xn, thereby generating four sustain discharges. The third period III is the same as the sustain period of the first subfield in which three sustain discharges are generated, and, like the sustain period of the first subfield, is followed by an erase period. Thus, the sustain period of the first subfield may be considered to be a period III. Therefore, the number of sustain discharges generated during the sustain period of the second subfield is seven (four during the period I and three during the period III), which is about twice the number of three sustain discharges generated during the sustain period of the first subfield, such that a weight value of the second subfield is about twice a weight value of the first subfield. During the second period II, the Ve voltage is applied to the sustain electrodes X1 to Xn, and the reference voltage OV is applied to the first scan electrode group TG1. Since the last sustain pulse of the first period I was applied to the sustain electrodes X1 to Xn, no discharge is generated during the second period II. The second period II is used to generate no discharge in the discharge cells formed along the first scan electrode group YG1, and is also used as a reset period or an address period for the other scan electrode groups YG2 to YGn. That is, a reset waveform or a scan pulse is applied to the other scan electrode groups YG2 to YGn during the second period II.

In each of the third subfield to the eighth subfield, the first period I and the second period II are repeated a predetermined number of times to perform a number of sustain discharges corresponding to a weight value of the subfield, and the third period III is placed at the end of the sustain period after the last repetition of the first period I and the second period II. That is, the order of the first periods I, the second periods II, and the third period III in the sustain periods of the third subfield to the eighth subfield is the first periodI, the second period II, the first period I, the second period II, . . . , the first period I, the second period II, and the third period II. The third subfield to the eighth subfield are the same as the first subfield except for the sustain period as described above, and accordingly detailed descriptions of the other parts of the third subfield to the eighth subfield will be omitted.

The composition of the sustain period in each of the first subfield to the eighth subfield can be expressed by the rule (I+II)·(2^{N-1}−1)+III and the weight of each of these subfields can be expressed as 2^{N-1}, where I is the period I, II is the period II, III is the period III, and N is the number of the subfield, as shown in detail in the following Table 1.

TABLE 1

| | | | | | Sustain Period | |
|---|---|---|---|---|---|---|
| Subfield | N | N − 1 | 2^{N-1} | 2^{N-1} − 1 | Composition | Weight |
| 1st | 1 | 0 | 1 | 0 | (I + II) · 0 + III | 1 |
| 2nd | 2 | 1 | 2 | 1 | (I + II) · 1 + III | 2 |
| 3rd | 3 | 2 | 4 | 3 | (I + II) · 3 + III | 4 |
| 4th | 4 | 3 | 8 | 7 | (I + II) · 7 + III | 8 |
| 5th | 5 | 4 | 16 | 15 | (I + II) · 15 + III | 16 |
| 6th | 6 | 5 | 32 | 31 | (I + II) · 31 + III | 32 |
| 7th | 7 | 6 | 64 | 63 | (I + II) · 63 + III | 64 |
| 8th | 8 | 7 | 128 | 127 | (I + II) · 127 + III | 128 |

Thus, as shown in Table 1, the composition of the sustain period in the first subfield is III, the composition of the sustain period in the second subfield is I+II+III, the composition of the sustain period in the third subfield is I+II+I+II+I+II+III, the composition of the sustain period in the fourth subfield is I+Ii+I+II+I+II+I+Ii+I+II+I+II+I+II+II, and so forth. However, the rule (I+II)·(2^{N-1}−1)+III specifying the composition of the sustain periods of the subfields is merely one example of a suitable rule, and other rules may be used. Furthermore, although there are eight subfields in the example described above, a lesser or greater number of subfields may be used.

If the second period II of the sustain period is not used as a reset period or an address period for the other scan electrode groups, an erase addressing operation may be performed by applying erase address waveforms to the first scan electrode group YG1 and the address electrodes A1 to Am during the second period II, rather than applying the waveforms shown in FIG. 3 to the first scan electrode group YG1 and the address electrodes A1 to Am during the second period II. This increases the number of grayscales because the erase address waveforms are applied to select discharge cells in which sustain discharges are to be produced during the third sustain period III from the discharge cells in which sustain discharges were produced during the first sustain period I. The erase address waveforms are well known to those skilled in the art, and accordingly a detailed description thereof will be omitted.

Although the driving waveform applied to the first scan electrode group YG1 of the plurality of scan electrode groups YG1 to YGn is shown in FIG. 3 for convenience of description, the same driving waveform is applied to the other scan electrode groups YG2 to YGn but at respective timings that are different from a timing at which the driving waveform is applied to the first scan electrode group TG1.

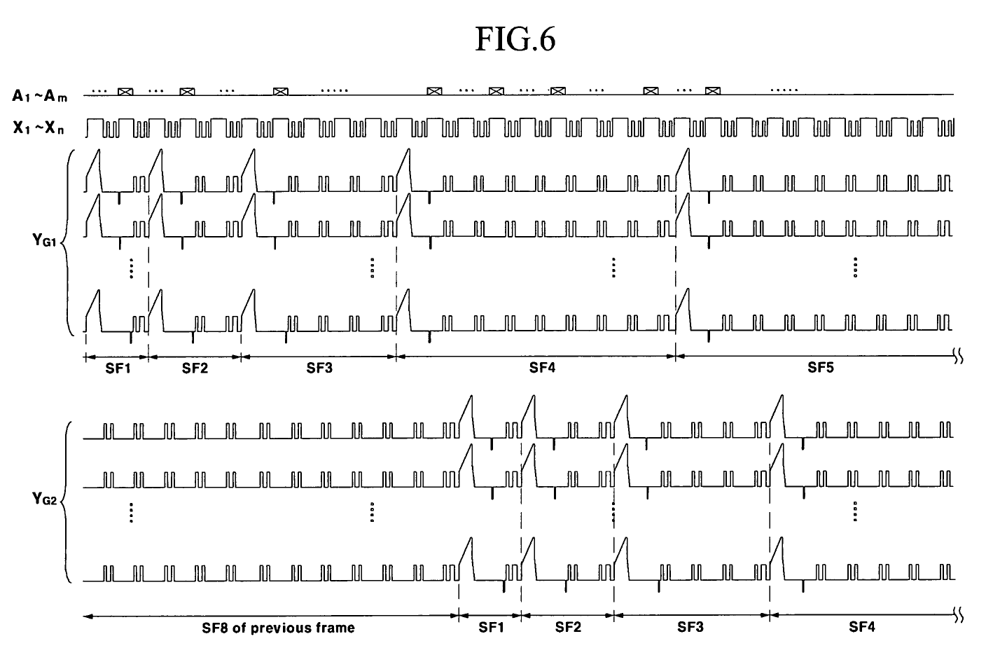

FIG. 6 shows driving waveforms applied to the first and second scan electrode groups YG1 and YG2. As shown in FIG. 6, the driving waveform applied to the second scan electrode group YG2 is the same as the driving waveform applied to the first scan electrode group YG1, but a timing at which the driving waveform is applied to the second scan electrode group YG2 is different from a timing at which the driving waveform is applied to the first scan electrode group TG1. That is, the operation of the first subfield SF1 of the second scan electrode group YG2 is performed while the sustain period operation of the fourth subfield SF4 of the first scan electrode group YG1 is being performed, and subsequently the operations of the subfields SF2 to SF8 of the second scan electrode group YG2 are performed. The reset waveform and the scan pulse waveform applied to the second scan electrode group YG2 are applied during second periods II of the sustain periods of predetermined subfields of the first scan electrode group TG1. In addition, the Ve voltage and the sustain pulses are alternately applied to the sustain electrodes X1 to Xn as shown in FIG. 6, and address data is applied to the address electrodes A1 to Am in synchronization with the scan pulses applied to the scan electrodes of the scan electrode groups as shown in FIG. 6 to perform the address operation to selected discharge cells to be turned on. While the operations of the first to third subfields SF1 to SF3 of the first scan electrode group YG1 and part of the operation of the fourth subfield SF4 of the first scan electrode group YG1 are being performed, part of the operation of the eighth subfield SF8 of the second scan electrode group YG2 that was not completed in a previous frame (corresponding to a TV field) is being performed. Accordingly, the reset and address periods of the subfields of different scan electrode groups do not overlap one other. That is, the reset and address periods of the subfields of the first scan electrode group YG1 do not overlap any of the reset and address periods of the subfields of any of the scan electrode groups YG2 to YGn, the reset and address periods of the subfields of the second scan electrode group YG2 do not overlap any of the reset and address periods of the subfields of any of the scan electrode groups YG1 and YG3 to YGn, and so on.

Respective timings at which the driving waveforms are applied to the other scan electrode groups YG3 to YGn are adjusted so that the AWD driving method shown in FIG. 2 may be used, similar to the manner in which the timing at which the driving waveform is applied to the second scan electrode group YG2 is adjusted as shown in FIG. 6.

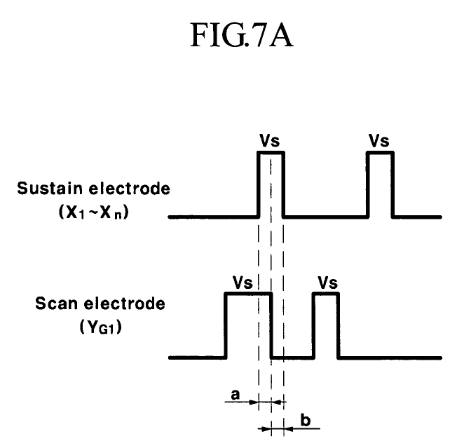

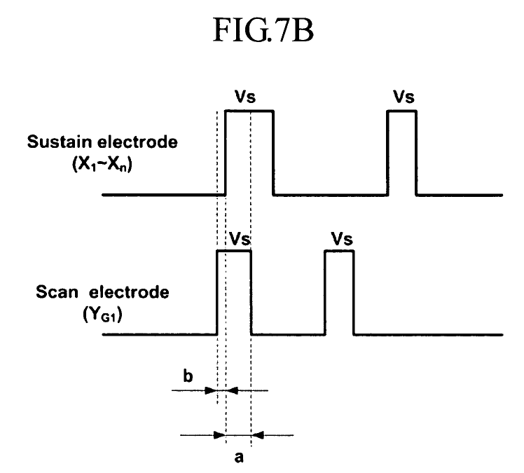

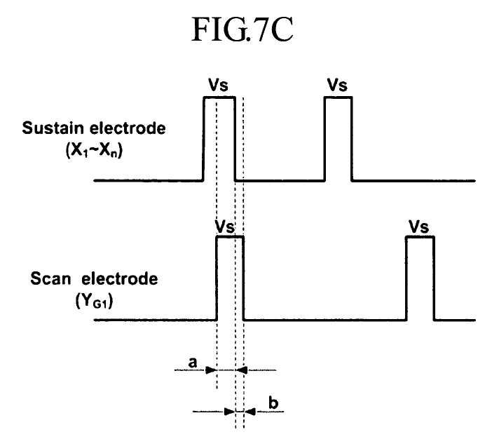

In addition to the address discharge, three sustain discharges are generated during the sustain period of the first subfield which is a least significant bit subfield as shown in FIG. 3, for a total of four discharges, ignoring the weak discharge generated during the erase period b. Four discharges are too many discharges to display a low grayscale, and therefore a method of improving the display of a low grayscale will be described with reference to FIG. 7A in which the erase period shown in FIG. 3 is moved to a different position to improve the display of a low grayscale.

FIGS. 7A, 7B, and 7C show a driving waveform in which the driving waveforms applied during the sustain period and the erase period of the first subfield shown in FIG. 3 are modified.

As shown in FIG. 7A, in the sustain period of the first subfield, a first sustain pulse is applied to the first scan electrode group YG1, and the erase periods a and b are provided at the end of this first sustain pulse applied to the first scan electrode group YG1, rather than at the end of the second sustain pulse applied to the first scan electrode group YG1 as shown in FIG. 3. This causes a sustain discharge to be generated between the first scan electrode group YG1 and the sustain electrodes X1 to Xn while the first sustain pulse is being applied to the first scan electrode group YG1, causes no discharge to be generated during the erase period a, and causes a weak discharge to be generated during the erase period b. The weak discharge eliminates some of the wall charges formed on the sustain electrode X and the scan electrode Y, resulting in the wall charge distribution shown in FIG. 4D. The remaining wall charges on the sustain electrode X and the scan electrode Y induce a wall voltage between the sustain electrode X and the scan electrode Y that is less than the wall voltage required to generate a sustain discharge between the sustain electrode X and the scan electrode Y using the sustain discharge voltage Vs. That is, in order to generate a sustain discharge between the sustain electrode X and the scan voltage Y, the sum of the wall voltage between the sustain electrode X and the scan voltage Y and the sustain discharge voltage Vs applied between the sustain electrode X and the scan electrode Y must be greater than a firing voltage. The wall voltage induced between the scan electrode X and the sustain electrode Y by the wall charge distributions shown in FIGS. 4B and 4C is high enough to satisfy this condition, but the wall voltage induced between the sustain electrode X and the scan electrode Y by the reduced number of charges in the wall charge distribution shown in FIG. 4 D produced by the weak discharge during the erase period b is not high enough to satisfy this condition. Next, a second sustain pulse is applied to the first scan electrode group YG1, but no sustain discharge is generated because, as discussed above, the wall voltage induced by the wall charges in the wall charge distribution shown in FIG. 4D produced by the weak discharge generated during the erase period b is not high enough to enable the sustain discharge to be generated using the sustain discharge voltage Vs of the second sustain pulse. Next, a sustain pulse is applied to the sustain electrodes X1 to Xn, but again no sustain discharge is generated for the same reason. This reduces the total number of discharges in the first subfield to two discharges (i.e., the address discharge and one sustain discharge, ignoring the weak discharge generated during the erase period b).

Furthermore, the position of the erase periods a and b and/or the order of the erase periods a and b may be changed to reduce the total number of discharges in the first subfield to one discharge (i.e., only the address discharge, ignoring the weak discharge generated during the erase period b).

FIG. 7B shows an example in which the erase periods a and b are provided at the beginning of the first sustain pulse applied to the first scan electrode group YG1 in the sustain period of the first subfield and their order is reversed so that the erase period b precedes the erase period a. This causes a weak discharge to be generated between the first scan electrode group YG1 and the sustain electrodes X1 to Xn during the erase period b, and causes no discharge to be generated during the erase period a. The weak discharge eliminates some of the wall charges formed on the sustain electrode X and the scan electrode Y, resulting in the wall charge distribution shown in FIG. 4D. As a result of this, no sustain discharge is generated by any of the sustain pulses applied in the sustain period of the first subfield, thereby reducing the total number of discharges in the first subfield to one discharge (i.e., only the address discharge, ignoring the weak discharge generated during the erase period b).

FIG. 7C shows an example in which the order of the sustain pulses in the sustain period of the first subfield is changed so that the first sustain pulse that is applied in the sustain period is applied to the sustain electrodes X1 to Xn, rather than to the first scan electrode group YG1 as shown in FIG. 3, and the erase periods a and b are provided at the end of this first sustain pulse applied to the sustain electrodes X1 to Xn. In this case, no sustain discharge is generated when the first sustain pulse is applied to the sustain electrodes X1 to Xn because the wall charge distribution at that time is the wall charge distribution shown in FIG. 4B, which has the wrong polarity for a sustain discharge to be generated by applying a sustain pulse to the sustain electrodes X1 to Xn. Next, no discharge is generated during the erase period a because the same Vs voltage is being applied to the sustain electrodes X1 to Xn and to the first scan electrode group TG1. Next, a weak discharge is generated during the erase period b. The weak discharge eliminates some of the wall charges formed on the sustain electrode X and the scan electrode Y, resulting in the wall charge distribution shown in FIG. 4D. As a result of this, no sustain discharge is generated by any of the sustain pulses applied in the sustain period of the first subfield, thereby reducing the total number of discharges in the first subfield to one discharge (i.e., only the address discharge, ignoring the weak discharge generated during the erase period b).

Although examples of different arrangements of the erase periods a and b have been shown in FIGS. 7A, 7B, and 7C, the invention is not limited to these arrangements, and other arrangements are possible. For example, by providing the erase periods a and b at the end of the first sustain pulse applied to the sustain electrodes X1 to Xn in the sustain period of the first subfield, instead of at the end of the second sustain pulse applied to the first scan electrode group YG1 as shown in FIG. 3, the total number of discharges in the first subfield can be reduced to three (i.e., the address discharge and two sustain discharges, ignoring the weak discharge generated during the erase period b).

By changing the arrangement of the erase periods a and b as described above, the number of discharges generated during the first subfield which is a least significant bit subfield can be adjusted, thereby adjusting the brightness of light emitted during the first subfield and improving the display of a low grayscale.

In a driving method of a plasma display device according to an aspect of the invention, a reset discharge is generated between the scan electrode and the address electrode during the reset period. Accordingly, various characteristics including an address voltage Va margin and a contrast ratio are increased as will now be described based on experimental results.

The following experimental results were obtained while conditions other than the parameters being measured were fixed when a driving method according to an aspect of the invention (i.e., the driving waveforms shown in FIG. 3) and a conventional driving method (i.e., a conventional ADS waveform or a conventional AWD waveform) were applied. In addition, in all of the experiments, the reset discharge generated during the reset period was appropriately generated as a weak discharge in the respective driving methods.

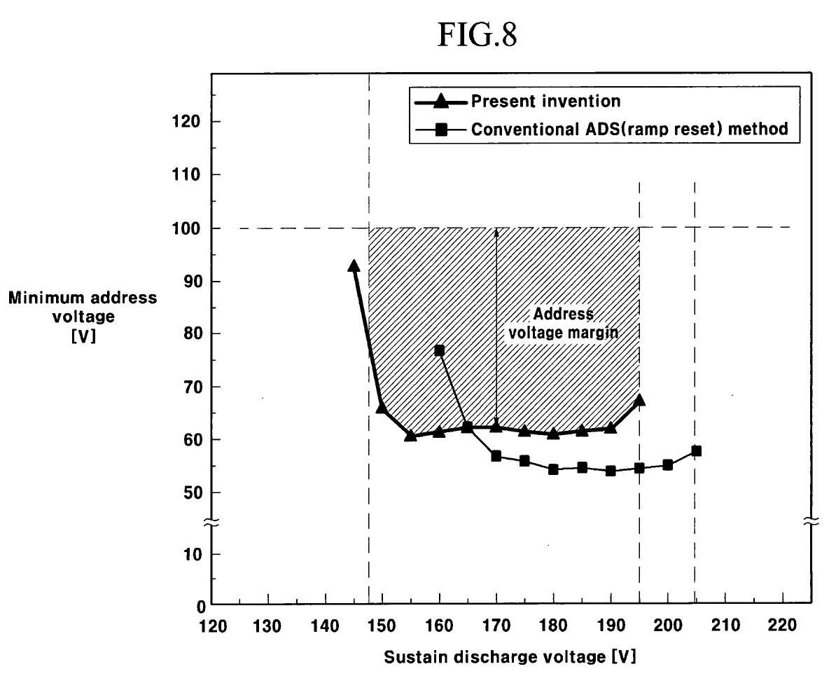

FIG. 8 shows a graph of a minimum address voltage versus a sustain discharge voltage when using a driving method according to an aspect of the invention and when using a conventional ADS driving method (i.e., a driving method in which a ramp reset waveform is applied during the reset period). “Minimum address voltage” means a minimum voltage required to generate an appropriate address discharge in a discharge cell selected to be turned on. The oblique-lined region in FIG. 8 shows an address voltage margin assuming that a voltage of an address driver is 100V.

As shown in FIG. 8, a sustain discharge voltage range of a driving method according to an aspect of the invention is different from that of the conventional ADS driving method. As shown in FIG. 8, the minimum address voltage starts to decrease rapidly at around 145V in a driving method according to an aspect of the invention. In contrast, the minimum address voltage does not start to decrease rapidly until around 160V in the conventional ADS driving method. This difference of about 15V is due to the change in the wall charge distribution produced during the erase period in a driving method according to an aspect of the invention. Accordingly, when using a driving method according to an aspect of the invention, a plasma display device may be stably driven using a lower sustain discharge voltage than in the conventional ADS driving method. In addition, in a driving method according to an aspect of the invention, the minimum address voltage is similar to that of the conventional ADS driving method as shown in FIG. 8.

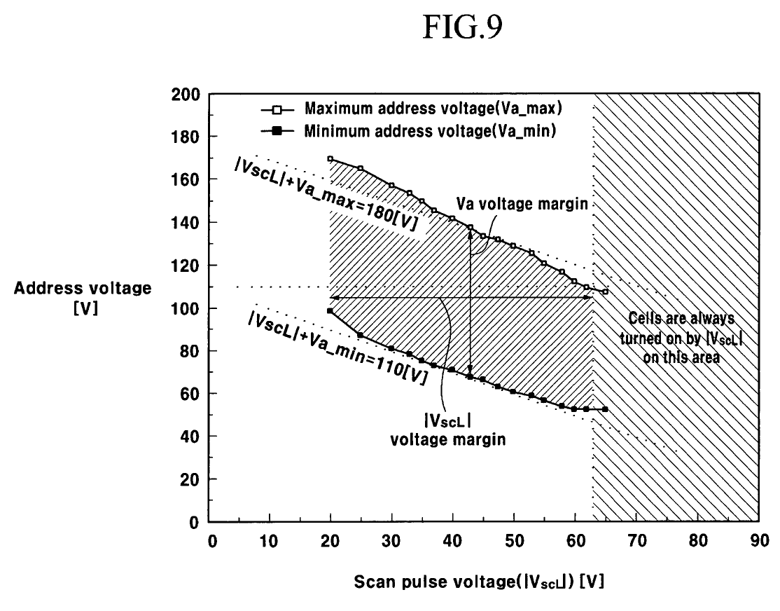

FIG. 9 shows a graph of an address voltage Va versus a scan pulse voltage |VscL|when using a driving method according to an aspect of the invention, and shows minimum address voltages Va_min and maximum address voltages Va_max that are generated when a predetermined scan pulse voltage |VscL| is applied.

In a conventional AWD driving method, the wall charges accumulated on the electrodes of all of the discharge cells are eliminated by using a strong pulse reset waveform. In order to generate an address discharge between an address electrode and a scan electrode, the sum of a wall voltage between the address electrode and the scan electrode and a voltage applied between the address electrode and the scan electrode must be greater than a firing voltage. Since all of the wall charges are eliminated by the strong pulse reset waveform in the conventional AWD driving method, there are no wall charges left to induce a wall voltage between the address electrode and the scan electrode. Since there is no wall voltage between the address electrode and the scan electrode, the voltage applied between the address electrode and the scan electrode must be higher than the firing voltage to generate an address discharge in the conventional AWD driving method. A typical firing voltage is 240V. Therefore, a voltage (|VscL|+Va) of more than 240V must be applied between the address electrode and the scan electrode to generate an address discharge in the conventional AWD driving method. However, as shown in FIG. 9, in a driving method according to an aspect of the invention, a voltage (|VscL|+Va_min) is about 110V and a voltage (|VscL|+Va_max) is about 180V, which is considerably lower than the more than 240V required in the conventional AWD driving method. In a driving method according to an aspect of the invention, rather than eliminating the wall charges accumulated on the electrodes by generating a strong discharge during the reset period like in the conventional AWD driving method, the wall charges accumulated on the electrodes are merely reduced by generating a weak discharge during the erase period b, thereby leaving some wall charges to induce a wall voltage between the address electrode and the scan electrode. This, together with the short ramp reset period used in a driving method according to an aspect of the invention, makes it possible to reduce the voltage (|VscL|+Va) that must be applied between the address electrode and the scan electrode to generate an address discharge in a driving method according to an aspect of the invention to substantially less than the more than 240V required in the conventional AWD driving method. In a driving method according to an aspect of the invention, a Va voltage margin is 80V and a |VscL| voltage margin is 45V.

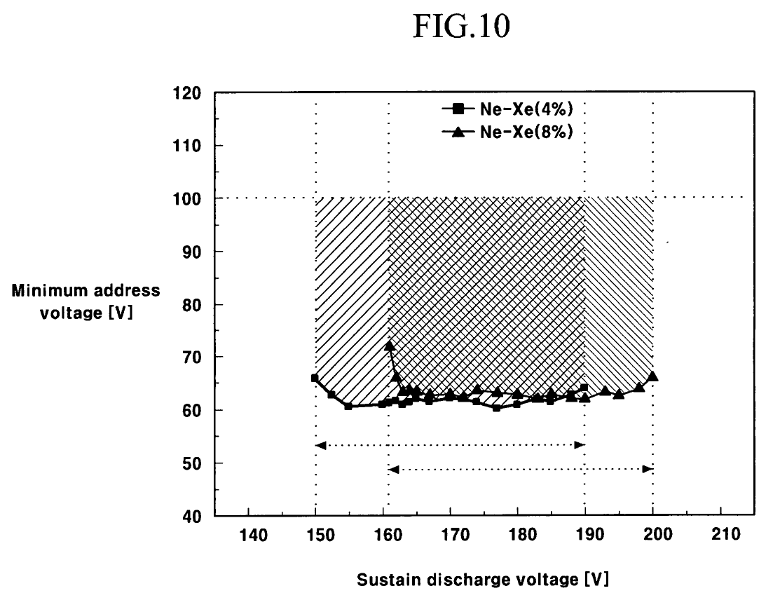

FIG. 10 shows a graph of a minimum address voltage versus a sustain discharge voltages when an amount of Xe in an Ne—Xe gas mixture is varied when using a driving method according to an aspect of the invention.

As shown in FIG. 10, a minimum address voltage hardly varies according to the amount of Xe when using a driving method according to an aspect of the invention. When using a conventional ADS driving method, it has been stated that the minimum address voltage greatly increases as the amount of Xe increases, but when using a driving method according to an aspect of the invention, the minimum address voltage hardly varies. Brightness and efficiency of a plasma display device increase as the amount of Xe increases, and accordingly the amount of Xe used in a plasma display device is likely to be increased in the future. However, there may be a limit to how much Xe can be used in that a driving voltage may increase as the amount of Xe is increased. However, since increases in the address voltage and the sustain discharge voltage resulting from an increase in the amount of Xe are less when using a driving method according to an aspect of the invention than when using than in a conventional driving method, a larger amount of Xe may be used in a plasma display device when using a driving method according to an aspect of the invention.

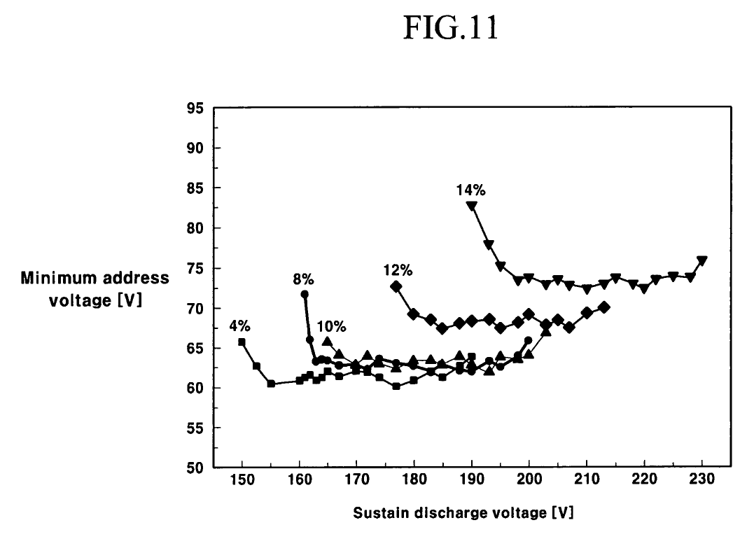

FIG. 11 shows a graph of a minimum address voltage versus a sustain discharge voltage when an amount of Xe in an Ne—Xe gas mixture is varied from 4% to 14% when using a driving method according to an aspect of the invention. As shown in FIG. 11, the minimum address voltage increases as the amount of Xe increases, but the increase is much less than in a conventional ADS driving method (i.e., a driving method in which a ramp reset waveform is applied during the reset period).

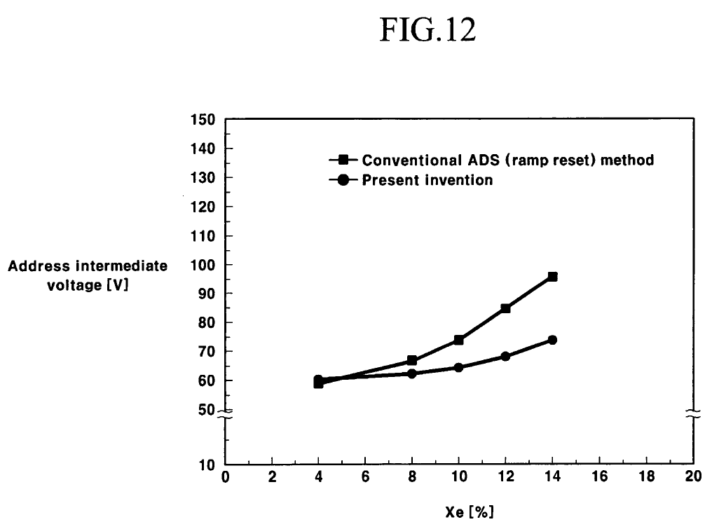

FIG. 12 shows a graph of an address intermediate voltage versus an amount of Xe in an Ne—Xe gas mixture when using a driving method according to an aspect of the invention obtained based on the graph shown in FIG. 11, in comparison with values obtained when using a conventional ADS driving method. The address intermediate voltage is a minimum address voltage at an intermediate value of the sustain discharge voltage in FIG. 11. As shown in FIG. 12, the address intermediate voltage increases as the amount of Xe increases when using a driving method according to an aspect of the invention, but the increase is much less than when using a conventional ADS driving method. For example, if the PDP 100 in FIG. 1 is filled with an Ne—Xe gas mixture with 14% of Xe, an address voltage of at least 100V is required to perform a stable addressing operation when driving the PDP 100 using a conventional ADS driving method, whereas an address voltage of only at least 70V is required to perform a stable addressing operation when driving the PDP 100 using a driving method according to an aspect of the invention.

In a driving method according to an aspect of the invention, a gradually increasing reset waveform is applied to the scan electrodes during the reset period. This provides a higher contrast ratio than when using a conventional AWD driving method in which a strong pulse reset waveform is applied during the reset period.

The following Table 2 shows a background luminance and a contrast ratio when using a ramp reset waveform of a conventional ADS driving method and when using a ramp reset waveform of a driving method according to an aspect of the invention, for an Ne—Xe gas mixture with 8% of Xe. The various parameters used in the two driving methods are also shown in Table 2.

TABLE 2

| | Ramp Reset Waveform | | Ramp Reset Waveform | |
|---|---|---|---|---|
| | of Conventional ADS | | of Driving Method | |
| Parameter | Driving Method | | According to Aspect of Invention | |
| Vset | 390 | V | 340 | V |
| Ramp slope increase rate | 1.5 | V/μs | 8 | V/μs |
| Ramp slope decrease rate | 1.2 | V/μs | 40 | V/μs |
| Peak brightness | ≈720 | cd/m² | ≈654 | cd/m² |
| (1000 sustain discharge pulses) | | | | |
| Background luminance | 1.446 | cd/m² | 0.065 | cd/m² |
| Contrast ratio | 468:1 | | 10,200:1 | |
| Reset period | 360 | μs | 30 | μs |
| Vs | 200 | V | 180 | V |
| \|VscL\| | 70 | V | 50 | V |
| Ve | 180 | V | 180 | V |

As shown in Table 2, a conventional ADS driving method requires a high Vset voltage of 390 V and produces a low contrast ratio of 468:1 and a high background luminance of 1.446 cd/m², while a driving method according to an aspect of the invention requires a low Vset voltage of 340 V and produces a high contrast ratio of 10,200:1 and a low background luminance of 0.065 cd/m². That is, by using a driving method according to an aspect of the invention instead of a conventional ADS driving method, a lower Vset voltage is required and a lower background luminance and a higher contrast ratio are produced.

According to an aspect of the invention, a lower background luminance and a higher contrast ratio can be produced during a shorter reset period, a wide address driving margin can be obtained, and a plasma display device can be driven by applying a low driving voltage even when a large amount of Xe is used in an Ne—Xe gas mixture.

Although several embodiments of the invention have been shown and described, it would be appreciated by those skilled in the art that changes may be made in these embodiments without departing from the principles and spirit of the invention, the scope of which is defined in the claims and their equivalents.

What is claimed is:

1. A driving method for driving a plasma display device, the plasma display device comprising a plurality of first electrodes, a plurality of second electrodes, and a plurality of third electrodes crossing the plurality of first electrodes and the plurality of second electrodes, a plurality of discharge cells being formed where the plurality of third electrodes cross the plurality of first electrodes and the plurality of second electrodes, the plurality of first electrodes being divided into a plurality of groups each comprising at least one first electrode of the plurality of first electrodes, the driving method comprising:
performing a first subfield operation of a first subfield on the at least one first electrode of a first group of the plurality of groups;
wherein the performing of the first subfield operation comprises:
generating a reset discharge by applying a first voltage to the at least one first electrode of the first group, a second voltage to the plurality of second electrodes, and a third voltage to the plurality of third electrodes so that a first voltage difference between the first voltage applied to the at least one first electrode of the first group and the third voltage applied to the plurality of third electrodes is higher than a second voltage difference between the first voltage applied to the at least one first electrode of the first group and the second voltage applied to the plurality of second electrodes;
selecting a discharge cell to be turned on from ones of the discharge cells that are formed along the at least one first electrode of the first group; and
generating a sustain discharge in the selected discharge cell.

2. The driving method of claim 1, wherein the generating of the reset discharge comprises gradually increasing the first voltage difference and the second voltage difference by gradually changing one or more of the first voltage applied to the at least one first electrode of the first group, the second voltage applied to the plurality of second electrodes, and the third voltage applied to the plurality of third electrodes.

3. The driving method of claim 2, wherein the generating of the reset discharge further comprises gradually decreasing the first voltage difference and the second voltage difference by gradually changing one or more of the first voltage applied to the at least one first electrode of the first group, the second voltage applied to the plurality of second electrodes, and the third voltage applied to the plurality of third electrodes after the gradual increasing of the first voltage difference and the second voltage difference.

4. The driving method of claim 1, wherein the third voltage that is applied to the plurality of third electrodes is lower than the second voltage that is applied to the plurality of second electrodes; and
wherein the generating of the reset discharge comprises gradually increasing the first voltage applied to the at least one first electrode of the first group while the second voltage is being applied to the plurality of second electrodes and the third voltage is being applied to the plurality of third electrodes.

5. The driving method of claim 4, wherein the generating of the reset discharge further comprises gradually decreasing the first voltage applied to the at least one electrode of the first group while the second voltage is being applied to the plurality of second electrodes and the third voltage is being applied to the plurality of third electrodes after the gradual increasing of the first voltage..

6. The driving method of claim 1, wherein in the generating of the reset discharge, a first discharge is generated between the at least one first electrode of the first group and the plurality of third electrodes, and a second discharge weaker than the first discharge is generated between the at least one first electrode of the first group and the plurality of second electrodes.

7. The driving method of claim 1, further comprising performing a second subfield operation of a second subfield on the at least one first electrode of a second group of the plurality of groups while the first subfield operation is being performed on the at least one first electrode of the first group;
wherein the performing of the second subfield operation comprises performing an address period operation of the second subfield during at least a part of a sustain period of the first subfield during which the sustain discharge is generated in the selected discharge cell.

8. The driving method of claim 1, further comprising performing a second subfield operation of a second subfield on the at least one first electrode of a second group of the plurality of groups while the first subfield operation is being performed on the at least one first electrode of the first group;
wherein the selecting of the discharge cell to be turned on is performed during at least a part of a sustain period of the second subfield.

9. The driving method of claim 1, wherein the generating of the sustain discharge comprises alternately applying a sustain discharge voltage having a first period to the at least one first electrode of the first group and to the plurality of second electrodes during a sustain period of the first subfield so that the sustain discharge voltage is being applied to the at least one first electrode of the first group at an end of the sustain period; and
wherein the performing of the first subfield operation further comprises:
continuing to apply the sustain discharge voltage to the at least one first electrode of the first group during a second period beginning at the end of the sustain period;
applying the sustain discharge voltage to the plurality of second electrodes while the sustain discharge voltage is being applied to the at least one first electrode of the first group of first electrodes during the second period;
decreasing the voltage applied to the at least one electrode of the first group to a voltage lower than the sustain discharge voltage at an end of the second period; and
decreasing the voltage applied to the plurality of second electrodes to a voltage lower than the sustain discharge voltage at an end of a third period beginning at the end of the second period;
wherein the third period is shorter than the first period.

10. The driving method of claim 1, wherein the generating of the sustain discharge comprises:
discharging the selected discharge cell a predetermined number of times during a first period of a sustain discharge period of the first subfield;
stopping the sustain discharge during a second period of the sustain discharge period; and
discharging the selected discharge cell the predetermined number of times during a third period of the sustain discharge period.

11. The driving method of claim 10, further comprising performing a reset period operation of a second subfield or an address period operation of the second subfield on the at least one first electrode of a second group of the plurality of groups during the second period of the sustain discharge period of the first subfield.

12. A plasma display device comprising:
a plasma display panel (PDP) comprising a plurality of first electrodes, a plurality of second electrodes, and a plurality of third electrodes crossing the plurality of first electrodes and the plurality of second electrodes;
a controller operable to perform a control operation wherein one frame is divided into a plurality of subfields each comprising a reset period, an address period, and a sustain period, and an address period operation of a second subfield of the plurality of subfields is performed on a jth first electrode of the plurality of first electrodes during a first period that is at least a part of the sustain period of a first subfield of the plurality of subfields during which a sustain period operation of the first subfield is performed on an ith first electrode of the plurality of first electrodes; and
a driver operable to apply a first waveform to the ith first electrode, a first voltage to the plurality of second electrodes, and a second voltage lower than the first voltage to the plurality of third electrodes during the reset period of the first subfield;
wherein the first waveform increases to a third voltage that is higher than the first voltage and then decreases while the first voltage is being applied to the plurality of second electrodes and the second voltage is being applied to the plurality of third electrodes during the reset period of the first subfield.

13. The plasma display device of claim 12, wherein the first waveform gradually increases to the third voltage and then gradually decreases.

14. The plasma display device of claim 12, wherein during the reset period of the first subfield, a first discharge is generated between the ith first electrode and the plurality of third electrodes, and a second discharge weaker than the first discharge is generated between the ith first electrode and the plurality of second electrodes.

15. The plasma display device of claim 12, wherein the plurality of subfields each further comprises a second period between the reset period and the address period; and
wherein during the second period of the first subfield, a sustain discharge voltage is applied to the plurality of second electrodes a predetermined number of times while a predetermined voltage is applied to the ith first electrode.

16. The plasma display device of claim 15, wherein at least a part of a sustain period operation of at least one other subfield of the plurality of subfields is performed on a kth first electrode of the plurality of first electrodes during the second period of the first subfield.

17. The plasma display device of claim 15, wherein in each of the plurality of subfields, a voltage waveform having the first voltage applied to the plurality of second electrodes during the reset period of the first subfield and a voltage waveform applied to the plurality of second electrodes during the second period of the first subfield are alternately and repeatedly applied to the plurality of second electrodes.

18. The plasma display device of claim 12, wherein the sustain period operation of the first subfield generates a sustain discharge during the sustain period of the first subfield and stops the sustain discharge during the first period.
